(19) United States
(12) Patent Application Publication
(10) Pub. No.: US 2022/0391049 A1
(43) Pub. Date: Dec. 8, 2022

(54) DETERMINING USER INTERFACE SHORTCUTS FOR A WEARABLE DEVICE

(71) Applicant: Bank of America Corporation, Charlotte, NC (US)

(72) Inventor: Siten Sanghvi, Westfield, NJ (US)

(21) Appl. No.: 17/339,621

(22) Filed: Jun. 4, 2021

(51) Int. Cl. G06F 3/0482

(52) U.S. Cl. CPC G06F 3/0482

(57) ABSTRACT

According to certain embodiments, a wearable device comprises a memory operable to store a plurality of menu option candidates and one or more shortcuts, each of the one or more shortcuts associated with a respective menu option candidate. The wearable device further comprises a processor configured to determine that a user has initiated a service request, obtain a plurality of attributes associated with the service request, send the plurality of attributes to a server associated with an enterprise that provides service, receive service options from the server, and present the service options to the user via the graphical user interface. To obtain one or more of the plurality of attributes, the processor is operable to receive responses to menu options selected from the plurality of menu option candidates based on one or more of the shortcuts.

### TECHNICAL FIELD

Certain embodiments of the present disclosure relate generally to determining user interface shortcuts for a wearable device. For example, certain embodiments determine user interface shortcuts adapted to accommodate technical constraints of the wearable device, such as technical constraints associated with display screen dimensions, processing capacity, memory capacity, and/or power consumption constraints.

### BACKGROUND

A wearable device is a computing device that can be worn by a user. Certain wearable devices may be for general use. For example, in some cases, a wearable device may be mobile computing device that is particularly small in size. In some cases, a wearable device may be for a specialized purpose. Some wearable devices may include special sensors such as accelerometers, location sensors, thermometers, heart rate monitors, and/or other sensors. Examples of wearable devices may include computing devices worn on the wrist (such as a smartwatch), hung from the neck (like a necklace), strapped to the arm or leg, worn on the head (such as glasses, headphones, or a helmet), or worn elsewhere on the user or the user's clothing. Mobile computing devices that can be carried in a pocket or bag, such as smartphones or tablets, can also be considered wearable devices. In order for a device to be wearable (e.g., to be a wearable size, to support mobility, etc.), the wearable device may be subject to various technical constraints related to battery life, heat dissipation, processing capacity, memory capacity, software architecture, network connectivity, data management, and/or other constraints.

### SUMMARY

The wearable device disclosed in the present application provides a technical solution to the technical problems discussed above by leveraging shortcuts to facilitate selection of menu options from a plurality of menu option candidates. The disclosed wearable device provides several practical applications and technical advantages which include a process for presenting menu options in order to obtain a plurality of attributes associated with a service request. More specifically, this process allows a wearable device to identify a next menu option based on a shortcut that associates a response to a current menu option with the next menu option. Existing techniques are typically limited to a fixed menu structure that arranges menu options in a pre-determined structure. In contrast, certain embodiments of the disclosed process use machine learning to dynamically update the shortcuts, for example, based on a user profile or user patterns, so that the wearable device presents the menu options with a relatively high likelihood of being selected by the user. This process provides a practical application by improving the wearable device's ability to efficiently obtain attributes associated with a service request. This practical application not only improves the wearable device's ability to efficiently obtain attributes associated with a service request, but also improves the underlying network and the devices within the network. For example, certain embodiments improve the speed and accuracy of obtaining attributes such that the underlying network and the devices within the network may allocate resources associated with providing the requested service more efficiently and accurately.

The wearable device disclosed in the present application provides certain technical advantages. For context, wearable devices are often small in size so that they can be easily worn by a user. As an example, a wearable smartwatch may commonly have a face size smaller than two-by-two inches. To accommodate the small size, a wearable device may be subject to certain technical constraints, for example, in terms of display screen dimensions, processing capacity, memory capacity, power consumption, etc. The technical constraints associated with a wearable device present certain challenges. For example, it may not be practical for a wearable device to present a complex user interface, such as a web page with a complex navigational structure (e.g., numerous menu options, links, graphics, and/or other details). To operate more effectively within these technical constraints, certain embodiments determine menu options to present to a user based on shortcuts that simplify navigating the user interface of the wearable device and/or accommodate the display screen dimensions of a wearable device. In certain embodiments, the shortcuts allow for reducing the amount of information to be presented by the user interface, which may in turn yield technical advantages such as reducing the amount of time it takes the wearable device to present the information on the user interface, conserving processing capacity, memory capacity, and/or power that would otherwise be used in the absence of the shortcuts, and/or facilitating better user responsiveness.

According to certain embodiments, a wearable device comprises a memory and a processor operably coupled to a network interface and the memory. The memory is operable to store a plurality of menu option candidates and one or more shortcuts, each of the one or more shortcuts associated with a respective menu option candidate. The processor is configured to determine that a user has initiated a service request and to obtain a plurality of attributes associated with the service request. To obtain at least some of the plurality of attributes, the processor is configured to perform actions comprising presenting a current menu option to the user via a graphical user interface of the wearable device, receiving a response to the current menu option from the user via the graphical user interface, presenting a next menu option to the user, and receiving a response to the next menu option. The response to the current menu option comprises an attribute of the plurality of attributes, and the response to the next menu option comprises another attribute of the plurality of attributes. With respect to presenting the next menu option, the next menu option is selected from the plurality of menu option candidates based on a shortcut selected from the one or more shortcuts. The selected shortcut associates the response to the current menu option with the next menu option. The processor is further configured to send the plurality of attributes associated with the service request to a server associated with an enterprise that provides service, receive service options from the server, and present the service options to the user via the graphical user interface.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION

For a more complete understanding of the present disclosure and for further features and advantages thereof, reference is now made to the following description taken in conjunction with the accompanying example drawings, in which:

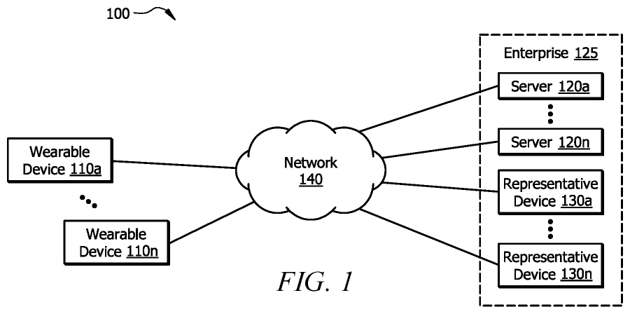

FIG. 1 illustrates an example of a system, in accordance with certain embodiments.

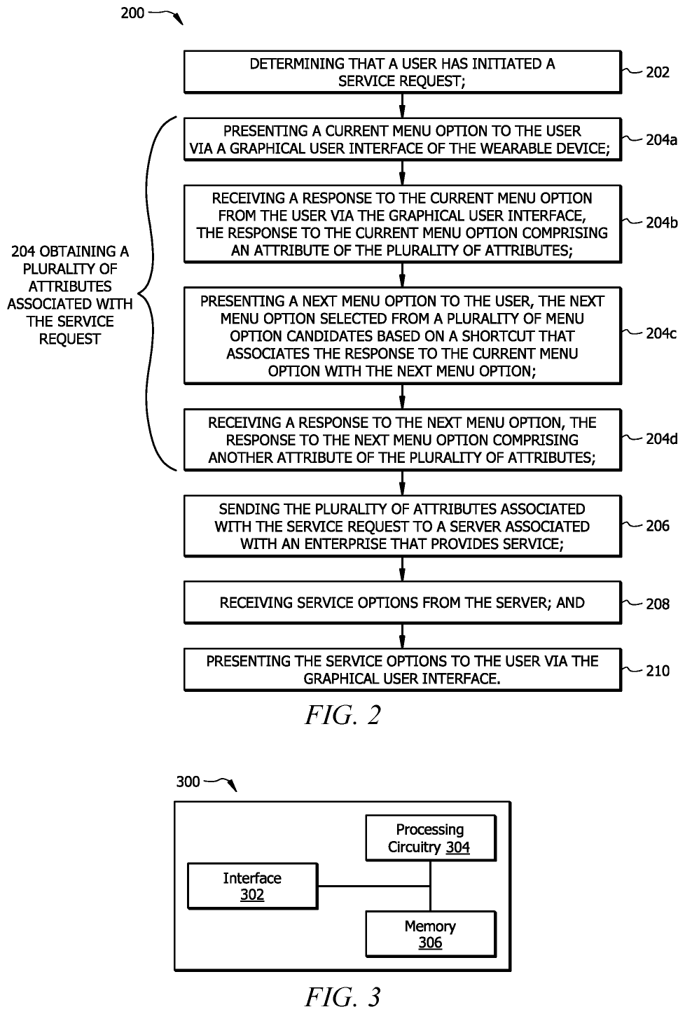

FIG. 2 illustrates an example of a method, in accordance with certain embodiments.

FIG. 3 illustrates an example of computing components, in accordance with certain embodiments.

### DETAILED DESCRIPTION

Certain embodiments of the present disclosure may be implemented in accordance with one or more of FIGS. 1-3, like numerals used to describe like components of the various figures. FIG. 1 illustrates an example of system 100, in accordance with certain embodiments. According to certain embodiments, system 100 comprises one or more wearable devices 110a-n, one or more servers 120a-n associated with an enterprise 125, and/or one or more representative devices 130a-n communicatively coupled via a network 140.

In general, wearable device 110 facilitates communication between a user and server(s) 120 and/or representative device(s) 130. For example, wearable device 110 may interact with the user via a graphical user interface in order to receive input from the user and present output to the user. In certain embodiments, wearable device 110 presents menu options requesting input from the user. In general, the menu options may be adapted based on the technical constraints of wearable device 110. For example, the menu options may be streamlined such that each menu option fits within the dimensions of the graphical user interface. As another example, the menu options may be arranged according to a simplified navigational structure. The navigational structure may use shortcuts to determine which menu options to present to the user. For example, the user may present a current menu option to the user, receive a response to the current menu option from the user, and present a next menu option to the user. The next menu option is selected from a plurality of menu option candidates based on a shortcut that associates the response to the current menu option with the next menu option. In this manner, wearable device 110 can reduce the amount of menu options that the user has to view and respond to. For example, if the response to the current menu option indicates that the user is interested in item X, the shortcut may navigate to a next menu option relevant to item X and skip menu options that are not relevant to item X.

In certain embodiments, wearable device 110 communicates requests obtained from the user to server 120, and server 120 responds to the requests. As an example, in certain embodiments, wearable device 110 facilitates receiving a service request from the user, obtaining attributes of the service request (e.g., based on presenting menu options to the user), and providing server 120 with the attributes of the service request. Server 120 then determines a response to the service request and communicates the response to wearable device 110. As an example, the response may indicate service options during which the user can meet with representative (e.g., a person using representative device 130) in order to receive service.

Wearable device 110 generally refers to a computing device that can be worn by a user and used by the user to interact with server 120 and/or representative 130 via network 140. Examples of wearable device 110 may include computing devices worn on the wrist (such as a smartwatch), hung from the neck (like a necklace), strapped to the arm or leg, worn on the head (such as glasses, headphones, or a helmet), worn elsewhere on the user or the user's clothing, or carried in a pocket or bag, such as smartphones or tablets.

Server 120 generally refers to hardware and/or software capable of communicating with wearable device 110 and/or representative device 130 via network 140. Examples of a server 120 may comprise one or more cloud-based servers, file servers, web servers, data centers, virtual machines, mainframe computers, etc. In certain embodiments, server 120 is associated with an enterprise 125. As an example, enterprise 125 could be a business that provides customer service to its customers. Server 120 may facilitate scheduling customer service appointments. For example, server 120 may receive a customer service request from a customer via wearable device 110, and server 120 may respond by providing customer service appointment options during which the customer may speak with a service representative.

Representative device 130 generally refers to a computing device that can be used by a representative, such as a service representative of enterprise 125. As an example, suppose enterprise 125 is a financial institution. The service representative could be a representative of the financial institution that works at a call center, a representative of the financial institution that works at a local bank branch, or other suitable representative of the financial institution. In certain embodiments, the representative uses representative device 130 to communicate with a customer that is a user of wearable device 110. In certain embodiments, the representative uses representative device 130 to communicate with server 120, for example, to indicate when the representative is available to meet with customers. Server 120 may use this information to determine service options to communicate to a customer that is a user of wearable device 110. Examples of representative device 130 include a workstation, a personal computer, a laptop, a tablet computer, a phone, a smartphone, a handheld device, a wireless device, etc.

Network 140 represents any suitable network(s) operable to facilitate communication between wearable device(s) 110, server(s) 120, and/or representative device(s) 130. Network 140 may include any interconnecting system capable of transmitting audio, video, signals, data, messages, or any combination of the preceding. Network 140 may include all or a portion of a public switched telephone network (PSTN), a cellular network, a base station, a gateway, a public or private data network, a local area network (LAN), a metropolitan area network (MAN), a wide area network (WAN), a wireless WAN (WWAN), a local, regional, or global communication or computer network, such as the Internet, a wireline or wireless network, an enterprise intranet, or any other suitable communication link, including combinations thereof, operable to facilitate communication between the components.

For purposes of example and explanation, FIG. 1 depicts the network as including certain components. However, this disclosure recognizes that the network may include any suitable components. One of ordinary skill in the art will appreciate that certain components can be omitted and other components not mentioned herein can be added. Additionally, components can be integrated or separated in any suitable manner. Similarly, functionality can be distributed or localized in any suitable manner.

FIG. 2 illustrates an example of a method 200 that may be performed by a wearable device 110, in accordance with certain embodiments. The method begins at step 202 with determining that a user has initiated a service request. As an example, certain embodiments may determine that the user has initiated a service request based on the user interacting with wearable device 120 to open a service application or to select a service menu option. In certain embodiments, a service menu option may be configured as a shortcut that causes wearable device 120 to present further menu options in order to obtain further information from the user about the requested service. In this manner, the user may connect with a service representative of enterprise 125 with few taps on their wearable device 110, without having to call in by phone and wait on hold.

At step 204, the method obtains a plurality of attributes associated with the service request. The attributes may indicate information about the requested service. In certain embodiments, the method obtains the attributes by presenting menu options to a user via a graphical user interface of wearable device 110. The user provides the attributes by selecting the menu options relevant to the user's request for service. Examples of attributes may include a department of enterprise 125 from which the user seeks service, a service of enterprise 125 for which the user seeks service, an action that the user would like to take, an in-person indicator indicating whether the service should be provided in person (e.g., at an store or office location of enterprise 125) or remotely (e.g., by phone or computer), a time preference for receiving service, or other information about the requested service.

As an example, suppose that enterprise 125 is a financial institution. In certain embodiments, the user may provide an attribute indicating that the service request applies to a particular department (e.g., retail banking, investment banking, wealth management, small business, etc.) and/or service (e.g., checking, savings, credit cards, lending, etc.). In certain embodiments, the user may provide an attribute indicating an action that the user would like to take (e.g., open account, close account, etc.). In certain embodiments, the user may provide an attribute setting an in-person indicator, such as an indicator set to “yes” if the user prefers to receive service in person, or to “no” if the user prefers to receive service remotely. In certain embodiments, the user may explicitly provide the in-person indicator (e.g., by selecting an “in-person” menu option or “remote” menu option). In certain embodiments, the user may implicitly provide the in-person indicator. For example, if the user requests a type of service that requires an in-person meeting to sign, witness, notarize, or otherwise verify documents, the request for that type of service may implicitly indicate that the user has requested an in-person service appointment. In certain embodiments, the user may provide an attribute indicating a time preference for receiving service. As an example, the time preference may request a callback from the next available representative. As another example, the user may interact with the menu presented by the graphical user interface to select one or more timeslots during which the user is available to receive a call back or to meet in person.

In certain embodiments, step 204 comprises sub-steps 204a-d. At step 204a, the method presents a current menu option to the user via a graphical user interface of the wearable device 110. As an example, the current menu option may provide a list of departments of enterprise 125. At step 204b, the method receives a response to the current menu option from the user via the graphical user interface. The response to the current menu option comprises an attribute of the plurality of attributes. Continuing with the example, the response may include the user's selection of one of the departments presented in step 204a.

At step 204c, the method presents a next menu option to the user. The method selects the next menu option from a plurality of menu option candidates based on a shortcut that associates the response to the current menu option with the next menu option. As an example, suppose that at step 204b, the user selected a retail banking department. The next menu option selected at step 204c based on the shortcut may present a list of services associated with the retail banking department. The list may exclude services associated with other departments. As another example, suppose that at step 204b, the user selected a wealth management department. The next menu option selected at step 204c based on the shortcut may present a list of services associated with the wealth management department. The list may exclude services associated with other departments. Or, if the wealth management department provides department-wide service (as opposed to service-specific service), it may be unnecessary to present a list of services menu option for the wealth management department. Instead, the next menu option selected at step 204c based on the shortcut may present a different menu, such as a list of actions associated with the wealth management department. Thus, certain embodiments determine which shortcut to use based on the response to the current menu option. Different shortcuts may lead to different menus and/or different menu options within the menus. Certain shortcuts may omit certain menus, exclude certain menu options, and/or re-prioritize which menu to present next based on the response to the current menu option. In this manner, shortcuts may be used to simplify the navigation structure.

At step 204d, the method receives a response to the next menu option. The response to the next menu option comprises another attribute of the plurality of attributes. Continuing with the example where the user selected the retail banking department in step 204b, the response in step 204d may indicate a service associated with the retail banking department, such as a checking service. Although the previous examples have described certain menu options, other embodiments may present different menu options and/or may arrange the menu options in a different order.

In certain embodiments, machine learning may be used to dynamically update the shortcuts or otherwise update the menu options. In certain embodiments, machine learning may determine that certain menu options do not apply to the user. In response, the machine learning may update the shortcuts so that wearable device 110 does not present the menu options that do not apply to the user. As an example, if machine learning determines that the user does not have a checking account, the machine learning may update the shortcuts so that wearable device 110 does not present the user with an option to close a checking account (i.e., such an option would not be relevant to a user that did not have a checking account). In certain embodiments, machine learning may update the shortcuts based on a user profile (e.g., accounts, products, or services associated the user or other user information) or user patterns (e.g., user history, user habits, etc.) so that wearable device 110 presents the menu options with a relatively high likelihood of being selected by the user. For example, the machine learning may determine that the user frequently uses a credit card and seldom uses a checking account. Based on this determination, the machine learning may determine that the user is more likely to request service for the credit card than for the checking account. Accordingly, the machine learning may update the shortcuts to present the user with menu options that allow the user to efficiently navigate credit card-related menu options. In certain embodiments, machine learning may determine that a user profile has changed over time, and machine learning may update the shortcuts based at least in part on the changes to the user profile. In certain embodiments, machine learning may determine that a user pattern has changed over time, and machine learning may update the shortcuts based at least in part on the changes to the user pattern.

In certain embodiments, the machine learning may be implemented in wearable device 110. In addition, or in the alternative, in certain embodiments, the machine learning may be implemented by server 120, and server 120 may indicate the shortcuts determined by the machine learning to wearable device 110 so that wearable device 110 can implement the shortcuts. For example, obtaining at least one of the plurality of attributes in step 204 may comprise receiving customization information from the server and presenting the user with a custom menu option that is based at least in part on the customization information. The customization information is based on a user profile or a user pattern. As an example, if server 120 determines that the user does not have a checking account, the customization information may indicate that the custom menu option need not include fields specific to providing service for an existing checking account. Certain embodiments may use the custom menu option for the current menu option described in step 204a, the next menu option described in step 204c, or for another menu option (such as a menu options for obtaining other attributes of the service request).

After obtaining the plurality of attributes associated with the service request, the method proceeds to step 206. At step 206, the method sends the plurality of attributes associated with the service request to a server 120 associated with enterprise 125 (such as a financial institution that provides service for financial products or services).

In certain embodiments, the wearable device 110 is further operable to send the server 120 a location associated with the user. A location associated with the user may be provided as an attribute of the service request or as a separate input. As examples, a location associated with a user could be a current location of the user, a future location of a user, or a preferred location of the user. Wearable device 110 may determine the current location of the user based on a location sensor (e.g., GPS sensor) or based on input from the user or a location service. Wearable device 110 may determine a future location of a user based on the user's past travel patterns (e.g., if the user is typically at work from 9:00 am-5:00 pm and at home after 5:00 pm) or based on input from the user (e.g., if the user indicates that the user will be in a certain location at a certain time). Wearable device 110 may determine a preferred location of the user based on input from the user. For example, an attribute of the service request could be one or more bank branches that the user prefers to go to for an in-person meeting, such as a first choice and a second choice depending on the time of the appointment or availability of a service representative. As another option, wearable device 110 may determine a preferred location of the user based on the user's history. For example, if the user has a history of typically going to a particular bank branch, wearable device 110 may determine that the user's preferred location corresponds to the particular bank branch.

Although the previous examples describe wearable device 110 providing server 120 with the location associated with the user, in certain embodiments, server 120 itself may determine at least some of the location information. As an example, analyzing a user's past travel patterns to predict a future location of the user or analyzing a user's history to determine a preferred location of the user could be performed by server 120.

At step 208, the method receives service options from the server 120. The service options may include one or more remote options (e.g., if the user prefers to receive a phone call), one or more in-person options (e.g., if the user prefers to meet in person or if the user is performing a type of transaction that requires an in-person appointment), or a combination of remote and in-person options. For the in-person case, the service options received from the server 120 are based at least in part on proximity to the location associated with the user.

In certain embodiments, the service options comprise a first service option to meet in-person at a first location at a first time and a second service option to meet in-person at a second location at a second time. For example, the first service option may be located at the user's preferred location, but the first time may be earlier or later than the user's preferred time. The second service option may be located at a different location (e.g., within a few miles of the user's preferred location), and the second time may be the user's preferred time. Thus, if there is a long wait time or a preferred timeslot is not available at the user's preferred location, the user can be offered another service option at a nearby location. The user may opt for either the first service option (e.g., if appointment location is more important to the user than appointment time) or the second service option (e.g., if appointment time is more important to the user than appointment location).

In certain embodiments, the service options comprise a first service option to meet in-person at a first location at a first time and a second service option to meet in-person at a second location at a second time, wherein the first location is based on a predicted location of the user during the first time and the second location is based on a predicted location of the user during the second time. For example, machine learning may analyze a user's past travel patterns to determine that at the first time (e.g., between 8:00 am and 9:00 am), the user is typically located near the first location (e.g., a bank branch near the user's home), and that at a second time (e.g., between 9:00 am and 11:00 am), the user is typically located near the second location (e.g., a bank branch near the user's work). Thus, the method may analyze the user's typical travel route and suggest convenient locations for the service appointment, such as near the user's home, near the user's work, near an intersection that the user passes on the way to or from home (or on the way to or from work), etc.

In certain embodiments, the service options are based at least in part on which representatives are available to provide a particular type of service. For example, different representatives may be trained to handle different types of service. In a financial institution, one representative may be trained to process mortgages, another representative may be trained to consult on wealth management, another representative may be trained to open and close checking accounts, etc. Suppose that at step 204 the user requested an appointment with a wealth management consultant. Such a request may be explicit (the user selects a menu option to meet with a wealth management consultant) or implicit (server 120 determines that the user has implicitly requested to meet with a wealth management consultant based on other attributes of the user's service request, such as the type of transaction requested by the user). Server 120 may select service options with a wealth management consultant. If server 120 determines that a wealth management consultant is not available at the location associated with the user, server 120 may provide service options indicating one or more nearby locations where a wealth management consultant is available. If server 120 determines that a wealth management consultant is not available at a time requested by the user, server 120 may provide service options indicating one or more other timeslots during which a wealth management consultant is available.

In certain embodiments, the service options may include one or more callback options. In certain embodiments, a callback option may include an option for immediate callback in order to speak with a next available service representative. In certain embodiments, the option for immediate callback may indicate an estimated wait time during which the user should expect to be placed on hold. For example, the estimated wait time may be based on current call volumes. In certain embodiments, the callback options may include one or more pre-determined times to receive a callback. Certain embodiments may schedule a pre-determined time as a timeslot. For example, the service options may include options for the representative to call during a 2:00-2:30 pm timeslot, a 2:30-3:00 pm timeslot, a 3:00-3:30 pm timeslot, and/or other timeslot(s)).

At step 210, the method presents the service options to the user via the graphical user interface. In response, wearable device 110 may receive a selection of one of the service options from the user via the graphical user interface and communicate the selection to server 120. Server 120 may then arrange for the appointment to occur based on the user's selection. As an example, server 120 may add the appointment to the representative's calendar, to the user's calendar, or both. As another example, server 120 may instruct a call center to automatically call the user at the user's selected callback time.

FIG. 3 illustrates an example of computing components 300, in accordance with certain embodiments. The computing components 300 may be used to implement any of the structures illustrated in FIG. 1, or one or more portions thereof, such as wearable device 110, server 120, representative device 130, and/or network 140. The computing components 300 may comprise any suitable hardware and/or software configured to perform the functionality described above. The computing components 300 may be implemented using shared hardware or separate hardware. In certain embodiments, computing components 300 may be distributed in a cloud network environment.

In certain embodiments, the components comprise one or more interface(s) 302, processing circuitry 304, and/or memory(ies) 306. In general, processing circuitry 304 controls the operation and administration of a structure by processing information received from memory 306 and/or interface 302. Memory 306 stores, either permanently or temporarily, data or other information processed by processing circuitry 304 or received from interface 302. Interface 302 receives input, sends output, processes the input and/or output and/or performs other suitable operations. An interface 302 may comprise hardware and/or software.

Examples of interfaces 302 include user interfaces, network interfaces, and internal interfaces. Examples of user interfaces include one or more graphical user interfaces (GUIs), buttons, microphones, speakers, cameras, and so on. Network interfaces receive information from or transmit information through a network, perform processing of information, communicate with other devices, or any combination of the preceding. Network interfaces may comprise any port or connection, real or virtual, wired or wireless, including any suitable hardware and/or software, including protocol conversion and data processing capabilities, to communicate through a LAN, WAN, or other communication system that allows processing circuitry 304 to exchange information with or through a network. Internal interfaces receive and transmit information among internal components of a structure.

Processing circuitry 304 communicatively couples to interface(s) 302 and memory 306, and includes any hardware and/or software that operates to control and process information. Processing circuitry 304 may include a programmable logic device, a microcontroller, a microprocessor, any suitable processing device, or any suitable combination of the preceding. Processing circuitry 304 may execute logic stored in memory 306. The logic is configured to perform functionality described herein. In certain embodiments, the logic is configured to perform the method described with respect to FIG. 2.

Memory 306 includes any one or a combination of volatile or non-volatile local or remote devices suitable for storing information. For example, memory comprises any suitable non-transitory computer readable medium, such as Read Only Memory (“ROM”), Random Access Memory (“RAM”), magnetic storage devices, optical storage devices, or any other suitable information storage device or a combination of these devices. Memory 306 may be local/integrated with the hardware used by processing circuitry 304 and/or remote/external to the hardware used by processing circuitry 304.

The scope of this disclosure is not limited to the example embodiments described or illustrated herein. The scope of this disclosure encompasses all changes, substitutions, variations, alterations, and modifications to the example embodiments described or illustrated herein that a person having ordinary skill in the art would comprehend.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic.

Modifications, additions, or omissions may be made to the methods described herein without departing from the scope of the disclosure. The methods may include more, fewer, or other steps. Additionally, steps may be performed in any suitable order. That is, the steps of any method disclosed herein do not have to be performed in the exact order disclosed, unless explicitly stated.

As used in this document, “each” refers to each member of a set or each member of a subset of a set. Furthermore, as used in the document “or” is not necessarily exclusive and, unless expressly indicated otherwise, can be inclusive in certain embodiments and can be understood to mean “and/or.” Similarly, as used in this document “and” is not necessarily inclusive and, unless expressly indicated otherwise, can be inclusive in certain embodiments and can be understood to mean “and/or.” All references to “a/an/the element, apparatus, component, means, step, etc.” are to be interpreted openly as referring to at least one instance of the element, apparatus, component, means, step, etc., unless explicitly stated otherwise.

Furthermore, reference to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Although several embodiments have been illustrated and described in detail, it will be recognized that substitutions and alterations are possible without departing from the spirit and scope of the present disclosure, as defined by the appended claims.

1. A wearable device, the wearable device comprising:
a memory operable to store a plurality of menu option candidates and one or more shortcuts, each of the one or more shortcuts associated with a respective menu option candidate; and
a processor operably coupled to a network interface and the memory, and configured to:
determine that a user has initiated a service request;
obtain a plurality of attributes associated with the service request, wherein to obtain at least some of the plurality of attributes, the processor is configured to perform actions comprising:
presenting a current menu option to the user via a graphical user interface of the wearable device;
receiving a response to the current menu option from the user via the graphical user interface, the response to the current menu option comprising a first attribute of the plurality of attributes;
presenting a next menu option to the user, the next menu option selected from the plurality of menu option candidates based on a shortcut selected from the one or more shortcuts, wherein the selected shortcut associates the response to the current menu option with the next menu option;
receiving a response to the next menu option, the response to the next menu option comprising another attribute of the plurality of attributes; and
determining a second attribute of the plurality of attributes based on a past travel pattern of the user, the past travel pattern indicating where the user is typically located at a given time;
determining a third attribute of the plurality of attributes comprising an in-person indicator indicating whether the service should be provided in person or remotely;
determining a fourth attribute of the plurality of attributes comprising a time preference of the user to receive the service;
send the plurality of attributes associated with the service request to a server associated with an enterprise that provides service;
receive service options from the server;
determine whether the in-person indicator indicates that the user wants to receive the service in person;
in response to determining that the in-person indicator indicates that the service should be provided in person, present a first set of service options from the service options to the user via the graphical user interface, wherein the first set of service options comprise a first service option to meet in-person at a first location at a first time and a second service option to meet in-person at a second location at a second time, the first location and the second location based on the past travel pattern of the user; and
in response to determining that the in-person indicator indicates that the service should be provided remotely, present a second set of service options from the service options to the user via the graphical user interface;
wherein the second set of service options comprises a third service option to remotely receive the service at a third time and a fourth service option to remotely receive the service at a fourth time, wherein the first time, the second time, the third time, and the fourth time are determined based at least in part upon the time preference of the user.

2. The wearable device of claim 1, wherein to obtain at least one of the plurality of attributes, the processor is further configured to:
receive customization information from the server, the customization information based on a user profile or a user pattern; and
present a custom menu option to the user, the custom menu option based at least in part on the customization information.

3. The wearable device of claim 1, wherein the processor is further configured to dynamically update at least one of the one or more shortcuts based on a user profile or user pattern.

4-5. (canceled)

6. The wearable device of claim 1, wherein the service options comprise a service option to be placed on hold in order to speak with a next available service representative and a service option to receive a call back at a pre-determined time.

7. The wearable device of claim 1, wherein the processor is further configured to send the server a location associated with the user, wherein the service options received from the server are based at least in part on proximity to the location associated with the user.

8. The wearable device of claim 1, wherein the processor is further configured to receive a selection of one of the service options from the user via the graphical user interface and to communicate the selection to the server.

9. A method for use in a wearable device, the method comprising:
determining that a user has initiated a service request;
obtaining a plurality of attributes associated with the service request, wherein obtaining at least some of the plurality of attributes comprises:
presenting a current menu option to the user via a graphical user interface of the wearable device;
receiving a response to the current menu option from the user via the graphical user interface, the response to the current menu option comprising a first attribute of the plurality of attributes;
presenting a next menu option to the user, the next menu option selected from a plurality of menu option candidates based on a shortcut that associates the response to the current menu option with the next menu option;
receiving a response to the next menu option, the response to the next menu option comprising another attribute of the plurality of attributes; and
determining a second attribute of the plurality of attributes based on a past travel pattern of the user, the past travel pattern indicating where the user is typically located at a given time;
determining a third attribute of the plurality of attributes comprising an in-person indicator indicating whether the service should be provided in person or remotely;
determining a fourth attribute of the plurality of attributes comprising a time preference of the user to receive the service;
sending the plurality of attributes associated with the service request to a server associated with an enterprise that provides service;
receiving service options from the server;
determining whether the in-person indicator indicates that the user wants to receive the service in person;
in response to determining that the in-person indicator indicates that the service should be provided in person, presenting a first set of service options from the service options to the user via the graphical user interface, wherein the first set of service options comprise a first service option to meet in-person at a first location at a first time and a second service option to meet in-person at a second location at a second time, the first location and the second location based on the past travel pattern of the user; and
in response to determining that the in-person indicator indicates that the service should be provided remotely, presenting a second set of service options from the service options to the user via the graphical user interface;
wherein the second set of service options comprises a third service option to remotely receive the service at a third time and a fourth service option to remotely receive the service at a fourth time, wherein the first time, the second time, the third time, and the fourth time are determined based at least in part upon the time preference of the user.

10. The method of claim 9, wherein obtaining at least one of the plurality of attributes comprises:
receiving customization information from the server, the customization information based on a user profile or a user pattern; and
presenting a custom menu option to the user, the custom menu option based at least in part on the customization information.

11-12. (canceled)

13. The method of claim 9, wherein the service options comprise a service option to be placed on hold in order to speak with a next available service representative and a service option to receive a call back at a pre-determined time.

14. The method of claim 9, wherein the wearable device is further operable to send the server a location associated with the user, wherein the service options received from the server are based at least in part on proximity to the location associated with the user.

15. A non-transitory computer readable medium comprising logic that, when executed by processing circuitry, causes the processing circuitry to perform actions comprising:
determining that a user has initiated a service request;
obtaining a plurality of attributes associated with the service request, wherein obtaining at least some of the plurality of attributes comprises:
presenting a current menu option to the user via a graphical user interface of a wearable device;
receiving a response to the current menu option from the user via the graphical user interface, the response to the current menu option comprising a first attribute of the plurality of attributes;
presenting a next menu option to the user, the next menu option selected from a plurality of menu option candidates based on a shortcut that associates the response to the current menu option with the next menu option;
receiving a response to the next menu option, the response to the next menu option comprising another attribute of the plurality of attributes; and
determining a second attribute of the plurality of attributes based on a past travel pattern of the user, the past travel pattern indicating where the user is typically located at a given time;
determining a third attribute of the plurality of attributes comprising an in-person indicator indicating whether the service should be provided in person or remotely;
determining a fourth attribute of the plurality of attributes comprising a time preference of the user to receive the service;
sending the plurality of attributes associated with the service request to a server associated with an enterprise that provides service;
receiving service options from the server;
determining whether the in-person indicator indicates that the user wants to receive the service in person;
in response to determining that the in-person indicator indicates that the service should be provided in person, presenting a first set of service options from the service options to the user via the graphical user interface, wherein the first set of service options comprise a first service option to meet in-person at a first location at a first time and a second service option to meet in-person at a second location at a second time, the first location and the second location based on the past travel pattern of the user; and
in response to determining that the in-person indicator indicates that the service should be provided remotely, presenting a second set of service options from the service options to the user via the graphical user interface;
wherein the second set of service options comprises a third service option to remotely receive the service at a third time and a fourth service option to remotely receive the service at a fourth time, wherein the first time, the second time, the third time, and the fourth time are determined based at least in part upon the time preference of the user.

16-17. (canceled)

18. The non-transitory computer readable medium of claim 15, wherein the service options comprise a service option to be placed on hold in order to speak with a next available service representative and a service option to receive a call back at a pre-determined time.

19. The non-transitory computer readable medium of claim 15, wherein the plurality of attributes comprise at least one of: department, service, or action.

20. The non-transitory computer readable medium of claim 15, wherein the actions further comprise receiving a selection of one of the service options from the user via the graphical user interface and communicating the selection to the server.

21. The wearable device of claim 1, wherein a location where the user is typically located at the given time is based on data from a location sensor of the wearable device.

22. The wearable device of claim 1, wherein the first location is further based on a preferred location of the user determined by the server, the preferred location of the user based on a user history.
